(19) United States
(12) Patent Application Publication
(10) Pub. No.: US 2026/0342402 A1
(43) Pub. Date: Oct. 29, 2026

(54) TECHNIQUES FOR USER EQUIPMENT ANTENNA SELECTION IN WIRELESS COMMUNICATIONS BASED ON ENERGY SAVINGS OPERATIONAL MODES

(71) Applicant: QUALCOMM Incorporated, San Diego, CA (US)

(72) Inventors: Vasanthan RAGHAVAN, West Windsor Township, NJ (US); Tao LUO, San Diego, CA (US)

(21) Appl. No.: 19/534,632

(22) Filed: Feb. 9, 2026

Related U.S. Application Data
(60) Provisional application No. 63/793,527, filed on Apr. 23, 2025.

(51) Int. Cl. H04B 7/06; H04L 1/00; H04L 5/00

(52) U.S. Cl. CPC H04B 7/0626; H04B 7/0608; H04B 7/0632; H04L 1/0003; H04L 5/0051

(57) ABSTRACT

This disclosure provides methods, components, devices, and systems for techniques for user equipment (UE) antenna selection in wireless communications based on network energy savings (NES) operational modes at a network entity. For example, a UE may transmit a set of reference signals over a set of reference signal transmission opportunities, which may be measured at a network entity in accordance with multiple different NES modes at the network entity. The network entity may transmit a set of channel state information (CSI) metrics to the UE based on the measurements at the network entity, where each CSI metric may correspond to an antenna group of multiple available antenna groups at the UE. The UE may select an antenna group for communications with the network entity based on the provided CSI metrics and a NES operational mode of the network entity.

### CROSS REFERENCE

The present Application for Patent claims the benefit of U.S. Provisional Patent Application No. 63/793,527 by RAGHAVAN et al., entitled “TECHNIQUES FOR USER EQUIPMENT ANTENNA SELECTION IN WIRELESS COMMUNICATIONS BASE ON ENERGY SAVINGS OPERATIONAL MODES,” filed Apr. 23, 2025, assigned to the assignee hereof, and which is expressly incorporated by reference in its entirety herein.

### TECHNICAL FIELD

This disclosure relates generally to wireless communication, and more specifically to systems, devices, methods, and techniques associated with techniques for user equipment antenna selection in wireless communications based on energy savings operational modes.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving, from a network entity, a set of multiple channel state information (CSI) metrics for a set of multiple corresponding operational modes of the network entity, where each CSI metric corresponds to an antenna group of a set of multiple antenna groups of the UE, selecting a first antenna group of the set of multiple antenna groups of the UE based on at least a first CSI metric of the set of multiple CSI metrics and an operational mode of the network entity, and communicating with the network entity using the first antenna group in accordance with the first CSI metric of the set of multiple CSI metrics.

A UE for wireless communications is described. The UE may include a processing system that includes processor circuitry and memory circuitry that stores code. The processing system may be configured to cause the UE to receive, from a network entity, a set of multiple CSI metrics for a set of multiple corresponding operational modes of the network entity, where each CSI metric corresponds to an antenna group of a set of multiple antenna groups of the UE, select a first antenna group of the set of multiple antenna groups of the UE based on at least a first CSI metric of the set of multiple CSI metrics and an operational mode of the network entity, and communicate with the network entity using the first antenna group in accordance with the first CSI metric of the set of multiple CSI metrics.

Another UE for wireless communications is described. The UE may include means for receiving, from a network entity, a set of multiple CSI metrics for a set of multiple corresponding operational modes of the network entity, where each CSI metric corresponds to an antenna group of a set of multiple antenna groups of the UE, means for selecting a first antenna group of the set of multiple antenna groups of the UE based on at least a first CSI metric of the set of multiple CSI metrics and an operational mode of the network entity, and means for communicating with the network entity using the first antenna group in accordance with the first CSI metric of the set of multiple CSI metrics.

A non-transitory computer-readable medium storing code for wireless communications is described. The code may include instructions executable by one or more processors to receive, from a network entity, a set of multiple CSI metrics for a set of multiple corresponding operational modes of the network entity, where each CSI metric corresponds to an antenna group of a set of multiple antenna groups of the UE, select a first antenna group of the set of multiple antenna groups of the UE based on at least a first CSI metric of the set of multiple CSI metrics and an operational mode of the network entity, and communicate with the network entity using the first antenna group in accordance with the first CSI metric of the set of multiple CSI metrics.

Some examples of the method, UEs, and non-transitory computer-readable medium described herein may further include operations, features, means, or instructions for transmitting a set of multiple reference signals to the network entity over a set of multiple reference signal transmission opportunities, where at least a first reference signal transmission uses the first antenna group and at least a second reference signal transmission uses a second antenna group of the set of multiple antenna groups.

In some examples of the method, UEs, and non-transitory computer-readable medium described herein, each CSI metric of the set of multiple CSI metrics is associated with an operational mode of the set of multiple operational modes of the network entity. Some examples of the method, UEs, and non-transitory computer-readable medium described herein may further include operations, features, means, or instructions for receiving an indication of a mapping between each CSI metric and one of the set of multiple operational modes of the network entity. In some examples of the method, UEs, and non-transitory computer-readable medium described herein, one or more CSI metrics of a first operational mode may be extrapolated from a CSI metric of a second operational mode of the network entity.

In some examples of the method, UEs, and non-transitory computer-readable medium described herein, the set of multiple CSI metrics include one or more of an index value to a channel quality indicator (CQI) or modulation and coding scheme (MCS) table, an uplink signal to noise ratio (SNR), an uplink signal strength metric, an uplink channel impulse response (CIR) vector estimate, or any combination thereof. In some examples of the method, UEs, and non-transitory computer-readable medium described herein, the first antenna group may be selected based on the set of multiple CSI metrics and a network energy savings (NES) mode indicated by the network entity.

Some examples of the method, UEs, and non-transitory computer-readable medium described herein may further include operations, features, means, or instructions for transmitting an antenna group information message to the network entity that indicates the set of multiple antenna groups of the UE and available combinations of the set of multiple antenna groups. Some examples of the method, UEs, and non-transitory computer-readable medium described herein may further include operations, features, means, or instructions for transmitting an indication of which antenna groups of the set of multiple antenna groups of the UE is used for one or more uplink reference signal transmissions from the UE.

In some examples of the method, UEs, and non-transitory computer-readable medium described herein, the set of multiple CSI metrics include CQI or MCS feedback for two or more antenna groups of the set of multiple antenna groups of the UE, and the first antenna group includes one or more antennas of the UE that are included in one of the set of multiple antenna groups. In some examples of the method, UEs, and non-transitory computer-readable medium described herein, the set of multiple CSI metrics further indicate one or more alternate antenna groups that are available for selection at the UE.

Some examples of the method, UEs, and non-transitory computer-readable medium described herein may further include operations, features, means, or instructions for receiving an indication of the operational mode of the network entity and a time-period associated with a continuation of the operational mode, and where the first antenna group is selected based on the time-period associated with the operational mode.

A method for wireless communications by a network entity is described. The method may include receiving a set of multiple reference signals from a UE, transmitting a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE, and communicating with the UE using a first antenna group of the set of multiple antenna groups of the UE in accordance with an indicated operational mode.

A network entity for wireless communications is described. The network entity may include a processing system that includes processor circuitry and memory circuitry that stores code. The processing system may be configured to cause the network entity to receive a set of multiple reference signals from a UE, transmit a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE, and communicate with the UE using a first antenna group of the set of multiple antenna groups of the UE in accordance with an indicated operational mode.

Another network entity for wireless communications is described. The network entity may include means for receiving a set of multiple reference signals from a UE, means for transmitting a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE, and means for communicating with the UE using a first antenna group of the set of multiple antenna groups of the UE in accordance with an indicated operational mode.

A non-transitory computer-readable medium storing code for wireless communications is described. The code may include instructions executable by one or more processors to receive a set of multiple reference signals from a UE, transmit a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE, and communicate with the UE using a first antenna group of the set of multiple antenna groups of the UE in accordance with an indicated operational mode.

Some examples of the method, network entities, and non-transitory computer-readable medium described herein may further include operations, features, means, or instructions for receiving, from the UE, a set of multiple reference signals over a set of multiple reference signal transmission opportunities, where at least a first reference signal transmission uses the first antenna group and at least a second reference signal transmission uses a second antenna group of the set of multiple antenna groups at the UE. In some examples of the method, network entities, and non-transitory computer-readable medium described herein, each CSI metric of the set of multiple CSI metrics is associated with an operational mode of the set of multiple operational modes of the network entity.

Some examples of the method, network entities, and non-transitory computer-readable medium described herein may further include operations, features, means, or instructions for transmitting an indication of a mapping between each CSI metric and one of the set of multiple operational modes of the network entity. In some examples of the method, network entities, and non-transitory computer-readable medium described herein, one or more CSI metrics of a first operational mode may be extrapolated from a CSI metric of a second operational mode of the network entity. In some examples of the method, network entities, and non-transitory computer-readable medium described herein, the set of multiple CSI metrics include one or more of an index value to a CQI or MCS table, an uplink SNR, an uplink signal strength metric, an uplink CIR vector estimate, or any combination thereof.

Some examples of the method, network entities, and non-transitory computer-readable medium described herein may further include operations, features, means, or instructions for receiving an antenna group information message from the UE that indicates the set of multiple antenna groups of the UE and available combinations of the set of multiple antenna groups. Some examples of the method, network entities, and non-transitory computer-readable medium described herein may further include operations, features, means, or instructions for receiving an indication of which antenna groups of the set of multiple antenna groups of the UE are used for one or more uplink reference signal transmissions from the UE.

In some examples of the method, network entities, and non-transitory computer-readable medium described herein, the set of multiple CSI metrics include CQI or MCS feedback for two or more antenna groups of the set of multiple antenna groups of the UE, and the first antenna group includes one or more antennas of the UE that are included in one of the set of multiple antenna groups. In some examples of the method, network entities, and non-transitory computer-readable medium described herein, the set of multiple CSI metrics further indicate one or more alternate antenna groups that are available for selection at the UE.

Some examples of the method, network entities, and non-transitory computer-readable medium described herein may further include operations, features, means, or instructions for transmitting, to the UE, an indication of the operational mode of the network entity and a time-period associated with a continuation of the operational mode, and where the first antenna group is selected based on the time-period associated with the operational mode.

### BRIEF DESCRIPTION OF THE DRAWINGS

FIG. 1 shows an example of a wireless communication system.

FIG. 2 shows an example of a signaling configuration that supports techniques for user equipment (UE) antenna selection in wireless communications based on energy savings operational modes.

FIG. 3 shows an example of a process flow that supports techniques for UE antenna selection in wireless communications based on energy savings operational modes.

FIG. 4 shows a block diagram of a processing system that supports techniques for UE antenna selection in wireless communications based on energy savings operational modes.

FIG. 5 shows a diagram of a system including a device that supports techniques for UE antenna selection in wireless communications based on energy savings operational modes.

FIG. 6 shows a block diagram of a processing system that supports techniques for UE antenna selection in wireless communications based on energy savings operational modes.

FIG. 7 shows a diagram of a system including a device that supports techniques for UE antenna selection in wireless communications based on energy savings operational modes.

FIGS. 8 through 11 show flowcharts illustrating methods that support techniques for UE antenna selection in wireless communications based on energy savings operational modes.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, one or more network components (e.g., network entities such as transmission-reception points (TRPs), radio heads, radio units, base stations, gNodeBs, and the like) may perform NES techniques that may reduce energy consumption of the network. Various user equipment (UE) energy reduction techniques have been employed to help provide for longer battery life, and various energy reduction techniques are being investigated on the network side to help reduce overall network power consumption. A network entity that operates in a NES mode, for example, may enter a lower power state where one or more antenna panels of multiple antenna panels are inactivated. Such techniques may allow a network entity to dynamically adjust a quantity of activated antenna panels based on network conditions, which may reduce network power consumption. In some cases, communications with a UE may be established using one or more parameters determined based on a first set of active antenna panels at the network entity and may not be suitable for communications on a different set of active antenna panels at the network entity. For example, an antenna group of multiple available antenna groups at a UE may be selected based on the first set of active antenna panels at the network entity, and switching to a second set of active antenna panels at the network entity may result in having to determine a different antenna group at the UE. Such situations may reduce efficiency and increase latency in communications. Thus, techniques for enhancing communications efficiency and reliability for network entity NES operations may be desirable.

Aspects of the subject matter described in this disclosure relate to UE antenna selection based on energy savings operational modes of a network entity. For example, a UE may transmit a set of reference signals over a set of reference signal transmission opportunities, which may be measured at a network entity in accordance with multiple different NES modes at the network entity. The network entity may transmit a set of channel state information (CSI) metrics to the UE based on the measurements at the network entity, where each CSI metric may correspond to an antenna group of multiple available antenna groups at the UE (e.g., different combinations of one or more antennas or antenna panels at the UE). The UE may select an antenna group for communications with the network entity based on the provided CSI metrics and a NES operational mode of the network entity, and may communicate with the network entity in accordance with the selected antenna group and associated CSI metrics.

In some aspects, the network entity may indicate a mapping between NES operational modes and the associated CSI metrics that are fed back to the UE. The CSI metrics may include, for example, an index value of a channel quality information (CQI) or modulation and coding scheme (MCS), an uplink signal to noise ratio (SNR), an uplink channel impulse response (CIR) vector estimates, or any combination thereof. In some aspects, the UE may provide information to the network entity that indicates one or more constraints in terms of antenna grouping (e.g., which antennas make different groups and which joint antenna groups (JAGs) are active when the UE reference signs are transmitted). In some aspects, the network entity may provide CQI/MCS feedback for an antenna group combination indicated by UE, allowing UE antenna selection within a JAG. Additionally, or alternatively, the network entity may indicate alternate JAGs to select based on CSI metrics. In some aspects, the network entity may indicate the use of one or more NES operational modes for one or more time-periods (e.g., via layer 1 (L1), layer 2 (L2), or layer 3 (L3) signaling), and the UE may use the CSI metrics for antenna selection over the indicated time-period.

Aspects of the subject matter described in this disclosure can be implemented to realize one or more of the following potential advantages. In some examples, by providing CSI metrics associated with different NES operational modes, the described techniques can be used to select communication parameters at a UE (e.g., an antenna group) based on the CSI metrics and an indicated NES operational mode, which may enhance communications efficiency and reliability while also allowing reduced power consumption at the network entity. In some aspects, by providing one or more constraints for antenna grouping at the UE, the network entity may provide CSI metrics associated with available antenna groups at the UE, which may enhance efficiency are reduce latency for communications when a NES operational mode at the network changes. Additionally, or alternatively, by providing a time-period associated with an NES operational mode, the network entity may allow a UE to switch an antenna group for communications in accordance with a switching time at the network entity.

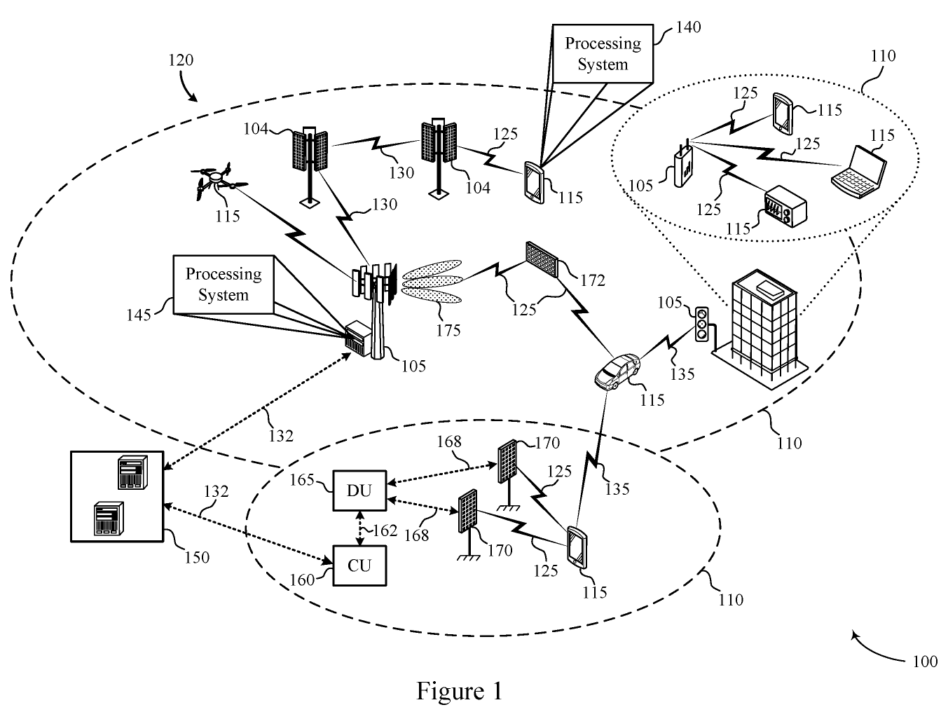

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna component” may refer to circuitry including one or more antennas as well as one or more other components (such as filters, amplifiers, processors, beamformers) associated with integrating the antenna component into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with an orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for techniques for UE antenna selection in wireless communications based on energy savings operational modes. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support providing CSI metrics to a UE associated with different NES operational modes, which may be used to select communication parameters at a UE and thereby enhance communications efficiency and reliability while also allowing reduced power consumption at the network entity.

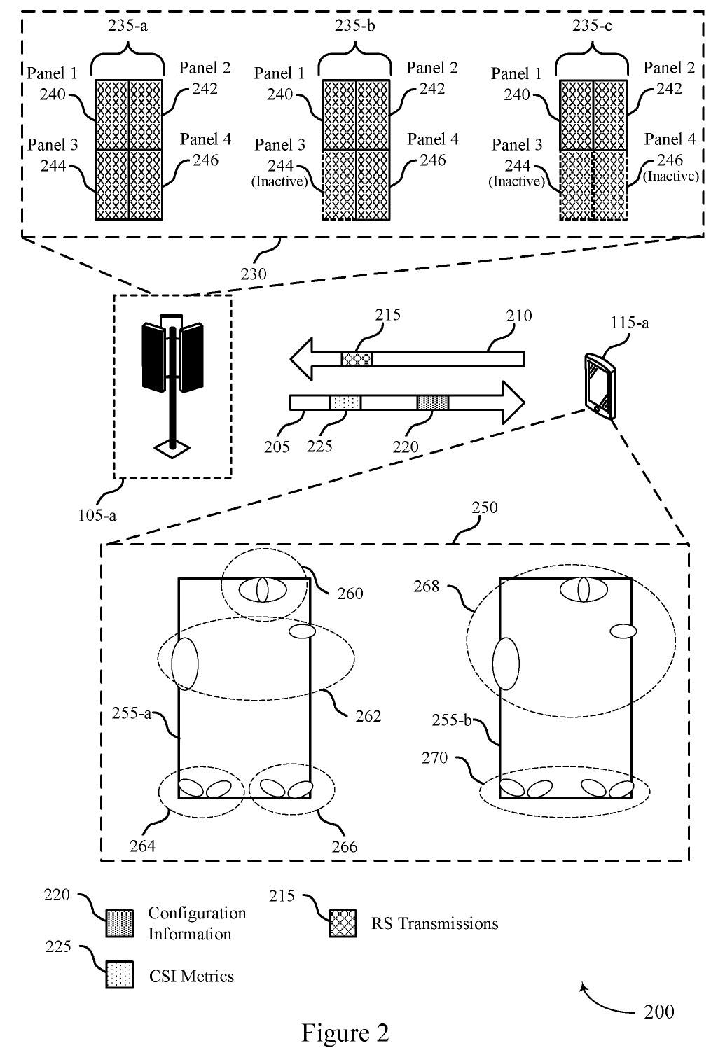

FIG. 2 shows an example of a signaling configuration 200 that supports techniques for UE antenna selection in wireless communications based on energy savings operational modes. For example, the signaling configuration 200 may include one or more UEs 115 (e.g., a UE 115-a) and one or more network entities 105 (e.g., a network entity 105-a), which may be examples of the corresponding devices as described herein.

In this example, the network entity 105-a and UE 115-a may communicate downlink communications via downlink channel 205 and uplink communications via uplink channel 210 (e.g., which may include TDD or FDD communications via one or more component carriers). In some aspects, the UE 115-a may transmit a set of reference signals 215 using a set of configured reference signal transmission occasions. The network entity may transmit configuration information 220 that may configure various aspects of communications, such as the transmission occasions for the reference signals 215, and one or more NES operational modes of the network entity 105-a, for example, The network entity 105-a may also transmit CSI metrics 225 based on measurements of the set of reference signals 215, as discussed herein.

In some aspects, the UE 115-a may include multiple antennas which may be located at different locations on the UE 115-a. For example, the UE 115-a may include six or eight antennas, and there may be more antennas than independent measurements that may be performed over each reference signal occasion. Further, a subset of antenna elements can be selected for power consumption reduction purposes. In some cases, the network entity 105-a may take (e.g., perform) uplink measurements and can recommend one or more antenna selection choice to UE as an antenna selection solution. Further, as discussed herein, in some implementations, the network entity 105-a may operate in one or more different NES modes, and the UE 115-a may also operate in one or more power savings modes. Thus, at a given time, out of N total antennas at the UE 115-a, K antennas (K ≤ N) can be selected in ^{N}C_{K} possibilities. However, network entity 105-a operation in NES and UE operation in power savings modes can constrain the number of possibilities in terms of selection.

In accordance with aspects as discussed herein, the network entity 105-a may report multiple (e.g., > 1) uplink CSI metrics 225 to UE to assist with antenna selection, where each of the CSI metrics 225 may correspond to a different NES operational modes and may be explicitly denoted. In some aspects, to enable NES, the network entity 105-a may turn off some sets or combinations of antennas, antenna panel, or frequency band combinations. For example, antenna panel configurations 230 may include a first combination of active antenna panels 235-a for a non-NES mode in which each of a first antenna panel 240, a second antenna panel 242, a third antenna panel 244, and a fourth antenna panel 246 may be activated. In a first NES mode, the antenna panel configurations may include a second combination of active antenna panels 235-b in which the third antenna panel 244 is inactive, and the first antenna panel 240, second antenna panel 242, and fourth antenna panel 246 may be activated. Further, a third NES mode, the antenna panel configurations may include a third combination of active antenna panels 235-c in which the third antenna panel 244 and fourth antenna panel 246 are inactive, and the first antenna panel 240, and the second antenna panel 242, may be activated. Thus, not every panel, antenna or band combination is possible at network entity 105-a side. Additionally, at the UE 115-a, pre-determined set of antennas can be formed for each layer using one or more JAGs. For example, antenna configuration 250 of the UE 115-a may include a first configuration 255-a in which two antennas are grouped in each of a first JAG 260, a second JAG 262, a third JAG 264, and a fourth JAG 266. In another example, antenna configuration 250 of the UE 115-a may include a second configuration 255-b in which four antennas are grouped in each of a fifth JAG 268 and a sixth JAG 270.

In some aspects, the UE 115-a may transmit uplink reference signals 215 signals over configured opportunities while network entity 105-a receives these signals in the appropriately self-configured NES mode (e.g., the non-NES operational mode, first NES operational mode, or second NES operational mode). In some aspects, the network entity may configure multiple reference signal transmission opportunities (e.g., SRS transmission opportunities) for different operational modes (e.g., the non-NES operational mode, first NES operational mode, or second NES operational mode). For example, in each operational mode, different combinations of panels, antennas, or bands may be active at the network entity 105-a. In some aspects, the network entity 105-a may make CQI/MCS determinations for each operational mode based on the reception of the uplink reference signals 215. In some aspects, the network entity 105-a may convey multiple (e.g., > 1) uplink CSI metrics 225 to the UE 115-a to enable antenna selection at the UE 115-a. In some aspects, each of the CSI metrics 225 may be associated with a specific operational mode at the network entity 105-a. For example, the network entity 105-a may indicate a mapping between an operational mode and one or more associated CSI metrics 225 that are fed back to the UE 115-a.

In some aspects, a quantity of operational modes may be configured by the network entity 105-a or may be left to network entity implementation. In some aspects, the network entity 105-a may extrapolate one or more CSI metrics 225 based on one operational mode to another operational mode for feedback. For example, the network entity 105-a may use uplink CSI metrics from the non-NES operational mode (e.g., all panels active) to the first NES operational mode (e.g., 3 panels active). In some aspects, the CSI metrics 225 may include, for example, one or more of CSI feedback (e.g., an index value to a CQI/MCS table, where the table could be based on reference signal data, control channel information, or a combination thereof), uplink SNR, uplink SINR, or uplink CRI vector estimates. In some aspects, the UE 115-a may select antennas for uplink transmissions based on information from the CSI metrics 225, an indication of an operational mode of the network entity 105-a, or any combination thereof. For example, the UE 115-a may select antennas for each NES operational mode at the network entity 105-a. In some aspects, the UE 115-a may conveys information to the network entity 105-a on constraints in terms of antenna grouping. For example, the UE 115-a may indicate which antennas make which groups and which JAGs are active when SRSs are transmitted (e.g., the UE 115-a can indicate a first JAG possibility when four SRSs are transmitted from JAG-1 to JAG-4, or may indicate a second JAG possibility when four SRSs are transmitted from JAG-1 and JAG-2). In some aspects, network entity 105-a may provide CQI/MCS feedback for the group combination indicated by UE 115-a, allowing antenna selection within a JAG at the UE 115-a. Further, the network entity 105-a may also indicate alternate JAGs to select based on uplink CSI measurements. Further, in some aspects, the network entity 105-a may indicate the use of one or more operational modes for one or more time-periods (e.g., via L1/L2/L3 signaling), and the UE 115-a may use uplink CSI metrics for antenna selection over the indicated time-period. In some aspects, the UE 115-a may provide a capability indication to the network entity 105-a that indicates whether antenna selection based on such techniques is supported at the UE 115-a.

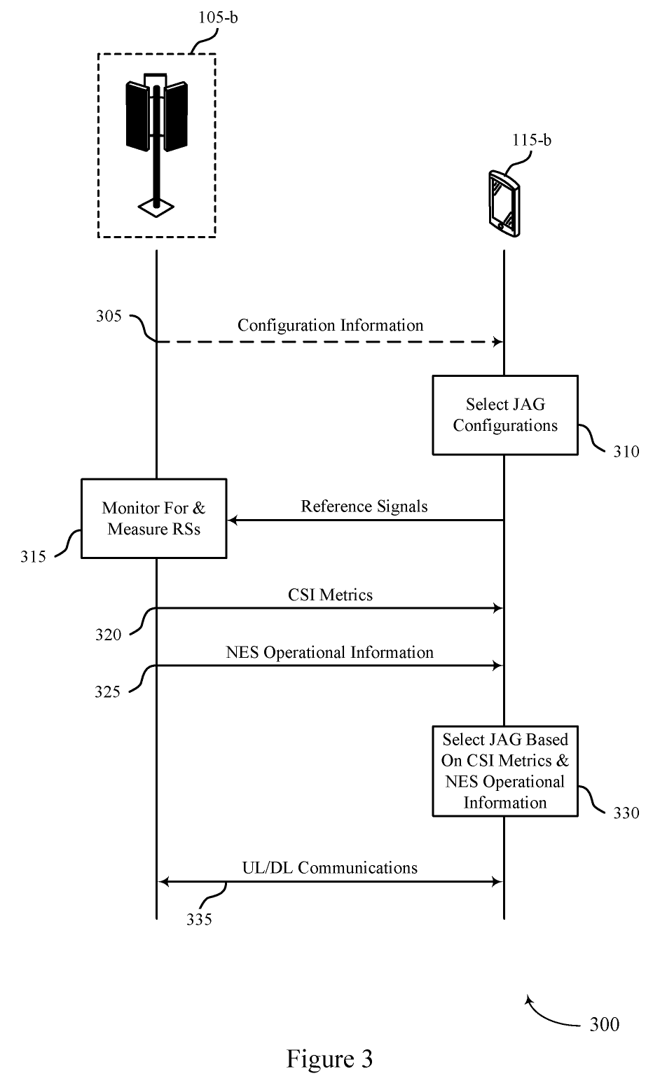

FIG. 3 shows an example of a process flow 300 that supports techniques for UE antenna selection in wireless communications based on energy savings operational modes. In some cases, the process flow 300 may implement or be implemented by aspects of the wireless communications system 100, the signaling configuration 200, or any combination thereof. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

In some cases, at 305, the network entity 105-b may transmit, and the UE 115-b may receive, configuration information related to uplink reference signal transmission occasions and antenna selection for different NES operational modes of the network entity 105-b, in accordance with techniques as discussed herein.

At 310, the UE 115-b may select one or more JAG configurations for communications with the network entity 105-b. For example, the UE 115-b may select a JAG configuration with two antennas per JAG or four antennas per JAG, such as based on a power savings mode of the UE 115-a, configuration information provided by the network entity 105-b, or any combination thereof. At 315, the UE 115-a may transmit, and the network entity 105-b may monitor for and measure, a set of uplink reference signals (e.g., SRSs), in accordance with techniques as discussed herein. In some aspects, as discussed herein, the network entity 105-b may measure the uplink reference signals using different NES operational modes, and may determine a set of CSI metrics based on the measurements. At 320, the network entity 105-b may transmit, and the UE 115-a may receive, the CSI metrics, in accordance with techniques as discussed herein.

At 325, the network entity 105-b may transmit an indication of NES operational information, which may be received at the UE 115-a. In some aspects, the NES operational information may indicate a current operational mode of the network entity 105-b, or may indicate one or more time-periods associated with one or more operational modes. At 330, the UE 115-a may select one or more antennas (e.g., one or more JAGs) for communications with the network entity 105-b based on the CSI metrics and NES operational information, in accordance with techniques as discussed herein. At 335, the UE 115-a and the network entity 105-b may perform uplink and downlink communications using the selected antennas and in accordance with the operational model of the network entity 105-b.

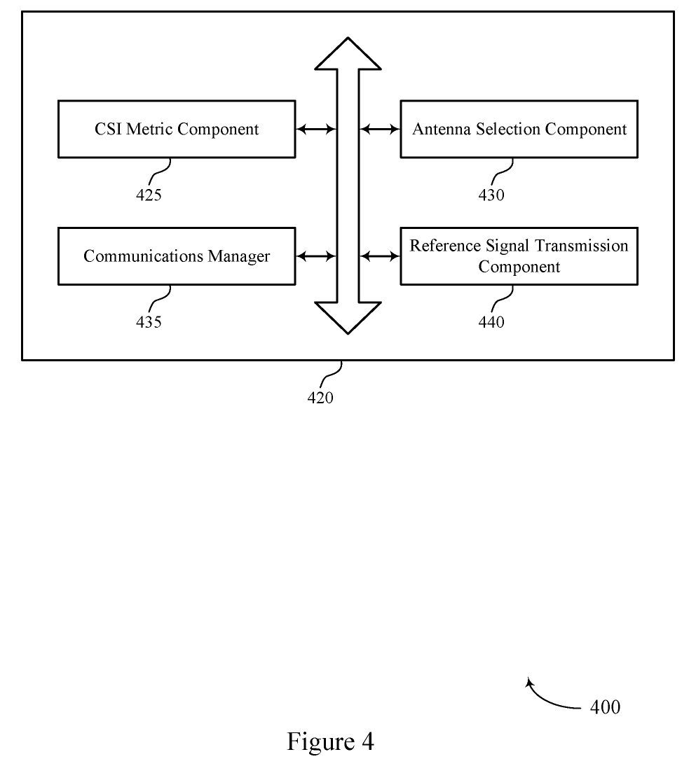

FIG. 4 shows an example 400 of a processing system 420 that supports techniques for UE antenna selection in wireless communications based on energy savings operational modes. A processing system 420 may be an example of a processing system 140 (such as of a UE 115) and may include a CSI metric component 425, an antenna selection component 430, a communications manager 435, a reference signal transmission component 440, or any combination thereof. A processing system 420, or various components thereof, may be an example of means for performing (such as a means for causing a UE 115 to perform) various techniques described herein.

The CSI metric component 425 may be configured to cause the UE 115 to receive, from a network entity, a set of multiple CSI metrics for a set of multiple corresponding operational modes of the network entity, where each CSI metric corresponds to an antenna group of a set of multiple antenna groups of the UE. The antenna selection component 430 may be configured to cause the UE 115 to select a first antenna group of the set of multiple antenna groups of the UE based on at least a first CSI metric of the set of multiple CSI metrics and an operational mode of the network entity. The communications manager 435 may be configured to cause the UE 115 to communicate with the network entity using the first antenna group in accordance with the first CSI metric of the set of multiple CSI metrics.

In some examples, the reference signal transmission component 440 may be configured to cause the UE 115 to transmit a set of multiple reference signals to the network entity over a set of multiple reference signal transmission opportunities, where at least a first reference signal transmission uses the first antenna group and at least a second reference signal transmission uses a second antenna group of the set of multiple antenna groups. In some examples, each CSI metric of the set of multiple CSI metrics is associated with an operational mode of the set of multiple operational modes of the network entity.

In some examples, the CSI metric component 425 may be configured to cause the UE 115 to receive an indication of a mapping between each CSI metric and one of the set of multiple operational modes of the network entity. In some examples, one or more CSI metrics of a first operational mode are extrapolated from a CSI metric of a second operational mode of the network entity. In some examples, the set of multiple CSI metrics include one or more of an index value to a CQI or MCS table, an uplink SNR, an uplink signal strength metric, an uplink CIR vector estimate, or any combination thereof.

In some examples, the first antenna group is selected based on the set of multiple CSI metrics and a network energy savings (NES) mode indicated by the network entity. In some examples, the antenna selection component 430 may be configured to cause the UE 115 to transmit an antenna group information message to the network entity that indicates the set of multiple antenna groups of the UE and available combinations of the set of multiple antenna groups. In some examples, the antenna selection component 430 may be configured to cause the UE 115 to transmit an indication of which antenna groups of the set of multiple antenna groups of the UE are used for one or more uplink reference signal transmissions from the UE.

In some examples, the set of multiple CSI metrics include CQI or MCS feedback for two or more antenna groups of the set of multiple antenna groups of the UE, and the first antenna group includes one or more antennas of the UE that are included in one of the set of multiple antenna groups. In some examples, the set of multiple CSI metrics further indicate one or more alternate antenna groups that are available for selection at the UE.

In some examples, the communications manager 435 may be configured to cause the UE 115 to receive an indication of the operational mode of the network entity and a time-period associated with a continuation of the operational mode, and where the first antenna group is selected based on the time-period associated with the operational mode.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for providing CSI metrics to a UE associated with different NES operational modes, which may be used at the UE to select communication parameters and thereby enhance communications efficiency and reliability while also allowing reduced power consumption at the network entity.

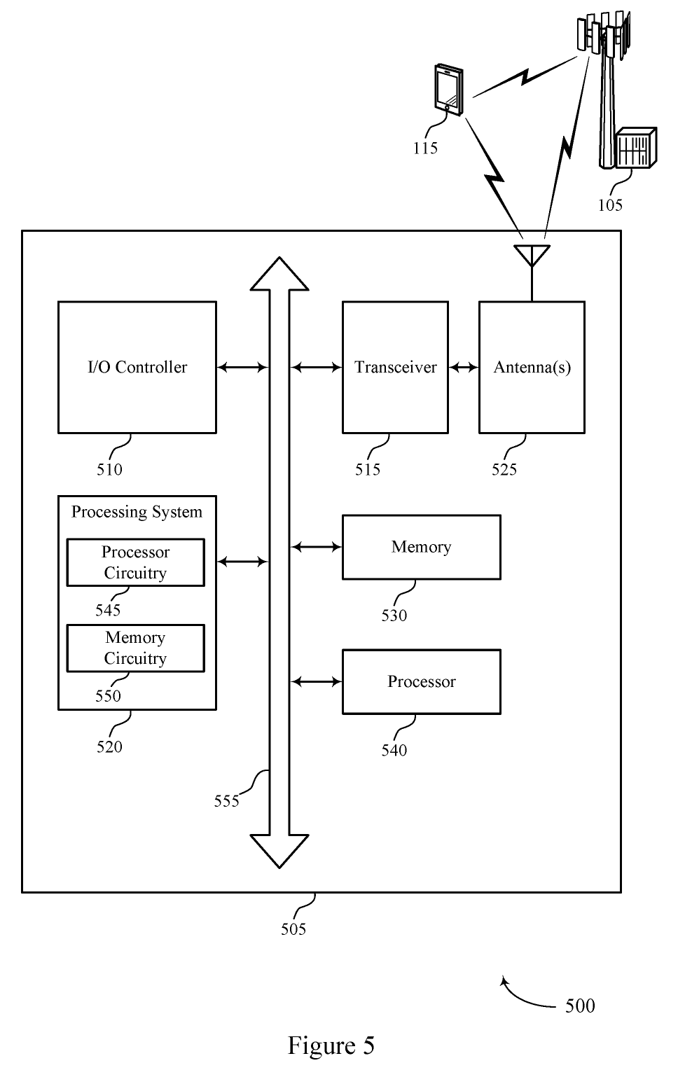

FIG. 5 shows an example of a system 500 including a device 505 that supports techniques for UE antenna selection in wireless communications based on energy savings operational modes. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support techniques for UE antenna selection in wireless communications based on energy savings operational modes. Although the processing system 520 is illustrated as a separate component, which may involve a separate chip, chipset, or other component, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for providing CSI metrics to a UE associated with different NES operational modes, which may be used at the UE to select communication parameters and thereby enhance communications efficiency and reliability while also allowing reduced power consumption at the network entity.

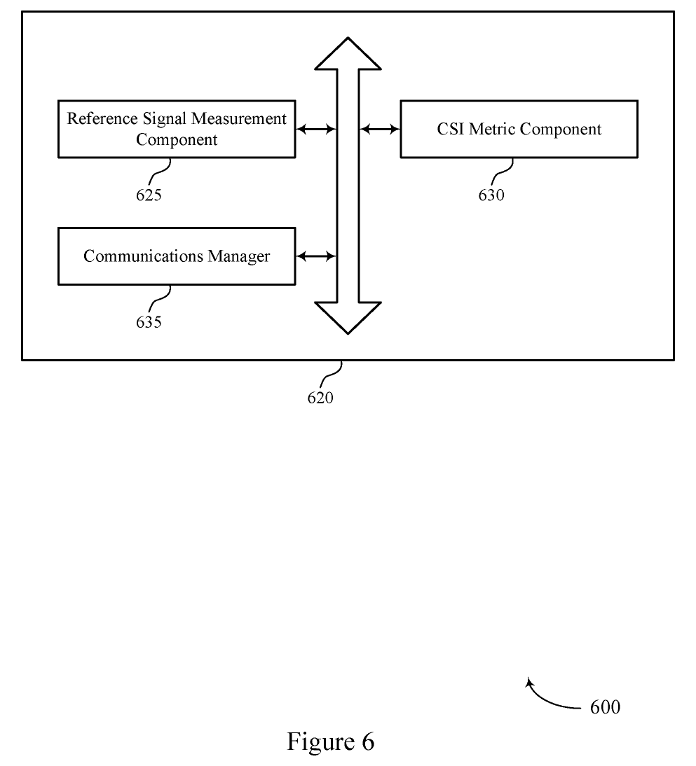

FIG. 6 shows an example 600 of a processing system 620 that supports techniques for UE antenna selection in wireless communications based on energy savings operational modes. A processing system 620 may be an example of a processing system 145 (such as network entity 105) and may include a reference signal measurement component 625, a CSI metric component 630, a communications manager 635, or any combination thereof. A processing system 620, or various component thereof, may be an example of means for performing (such as a means for causing a network entity 105 to perform) various techniques described herein.

The reference signal measurement component 625 may be configured to cause the network entity 105 to receive a set of multiple reference signals from a UE. The CSI metric component 630 may be configured to cause the network entity 105 to transmit a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE. The communications manager 635 may be configured to cause the network entity 105 to communicate with the UE using a first antenna group of the set of multiple antenna groups of the UE in accordance with an indicated operational mode.

In some examples, the reference signal measurement component 625 may be configured to cause the network entity 105 to receive, from the UE, a set of multiple reference signals over a set of multiple reference signal transmission opportunities, where at least a first reference signal transmission uses the first antenna group and at least a second reference signal transmission uses a second antenna group of the set of multiple antenna groups at the UE. In some examples, each CSI metric of the set of multiple CSI metrics is associated with an operational mode of the set of multiple operational modes of the network entity. In some examples, the CSI metric component 630 may be configured to cause the network entity 105 to transmit an indication of a mapping between each CSI metric and one of the set of multiple operational modes of the network entity. In some examples, one or more CSI metrics of a first operational mode are extrapolated from a CSI metric of a second operational mode of the network entity. In some examples, the set of multiple CSI metrics include one or more of an index value to a CQI or MCS table, an uplink SNR, an uplink signal strength metric, an uplink CIR vector estimate, or any combination thereof.

In some examples, the reference signal measurement component 625 may be configured to cause the network entity 105 to receive an antenna group information message from the UE that indicates the set of multiple antenna groups of the UE and available combinations of the set of multiple antenna groups. In some examples, the reference signal measurement component 625 may be configured to cause the network entity 105 to receive an indication of which antenna groups of the set of multiple antenna groups of the UE are used for one or more uplink reference signal transmissions from the UE. In some examples, the set of multiple CSI metrics include CQI or MCS feedback for two or more antenna groups of the set of multiple antenna groups of the UE, and the first antenna group includes one or more antennas of the UE that are included in one of the set of multiple antenna groups. In some examples, the set of multiple CSI metrics further indicate one or more alternate antenna groups that are available for selection at the UE.

In some examples, the communications manager 635 may be configured to cause the network entity 105 to transmit, to the UE, an indication of the operational mode of the network entity and a time-period associated with a continuation of the operational mode, and where the first antenna group is selected based on the time-period associated with the operational mode.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for providing CSI metrics to a UE associated with different NES operational modes, which may be used at the UE to select communication parameters and thereby enhance communications efficiency and reliability while also allowing reduced power consumption at the network entity.

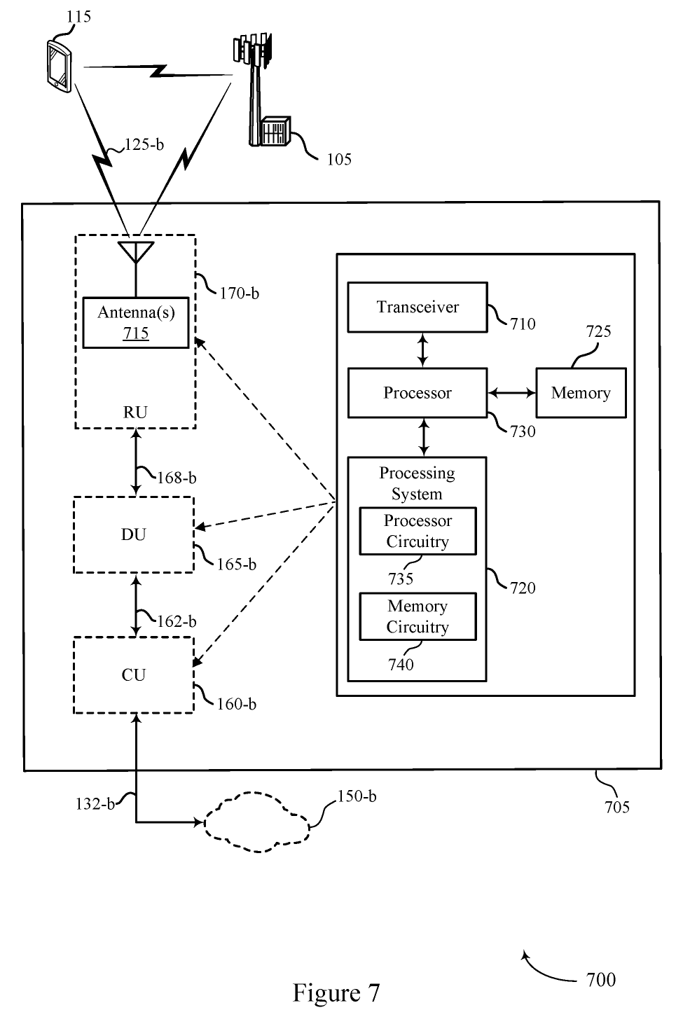

FIG. 7 shows an example of a system 700 including a device 705 that supports techniques for UE antenna selection in wireless communications based on energy savings operational modes. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 620. For example, the processing system 720 may include processor circuitry 735 and memory circuitry 740 that stores code, and the processing system 720 may be configured to cause the device 705 to perform operations that support techniques for UE antenna selection in wireless communications based on energy savings operational modes. Although the processing system 720 is illustrated as a separate component, which may involve a separate chip, chipset, or other component, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for providing CSI metrics to a UE associated with different NES operational modes, which may be used at the UE to select communication parameters and thereby enhance communications efficiency and reliability while also allowing reduced power consumption at the network entity.

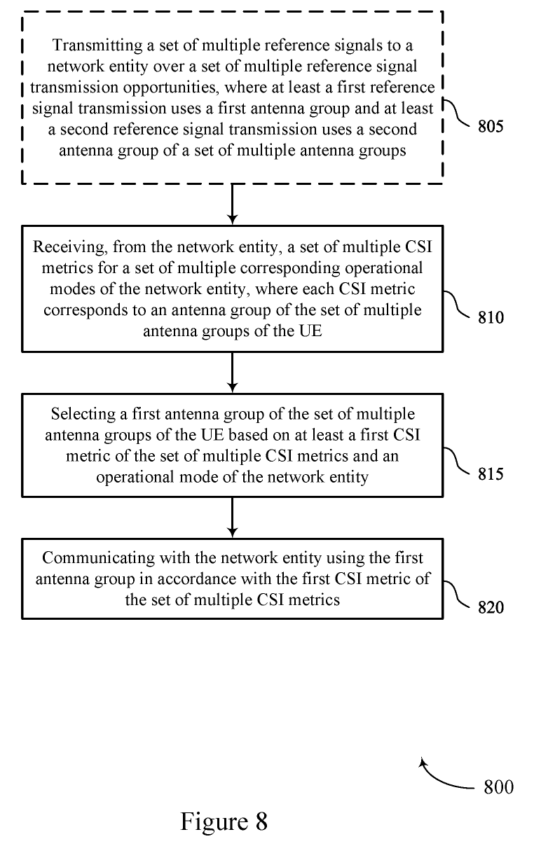

FIG. 8 shows an example of a method 800 that supports techniques for UE antenna selection in wireless communications based on energy savings operational modes. Operations of the method 800 may be performed by a UE or its components (such as using a processing system configured to cause the UE 115 to perform one or more of the operations) as described herein.

Optionally, at 805, the method may include transmitting a set of multiple reference signals to a network entity over a set of multiple reference signal transmission opportunities, where at least a first reference signal transmission uses a first antenna group and at least a second reference signal transmission uses a second antenna group of a set of multiple antenna groups. In some examples, aspects of the operations of 805 may be performed by a reference signal transmission component 440.

At 810, the method may include receiving, from the network entity, a set of multiple CSI metrics for a set of multiple corresponding operational modes of the network entity, where each CSI metric corresponds to an antenna group of the set of multiple antenna groups of the UE. In some examples, aspects of the operations of 810 may be performed by a CSI metric component 425.

At 815, the method may include selecting a first antenna group of the set of multiple antenna groups of the UE based on at least a first CSI metric of the set of multiple CSI metrics and an operational mode of the network entity. In some examples, aspects of the operations of 815 may be performed by an antenna selection component 430.

At 820, the method may include communicating with the network entity using the first antenna group in accordance with the first CSI metric of the set of multiple CSI metrics. In some examples, aspects of the operations of 820 may be performed by a communications manager 435.

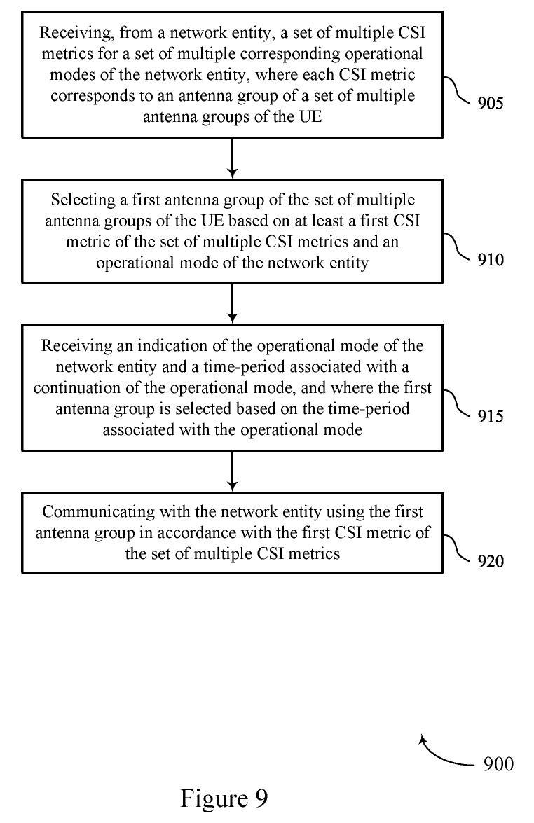

FIG. 9 shows an example of a method 900 that supports techniques for UE antenna selection in wireless communications based on energy savings operational modes. Operations of the method 900 may be performed by a UE or its components (such as using a processing system configured to cause the UE 115 to perform one or more of the operations) as described herein.

At 905, the method may include receiving, from a network entity, a set of multiple CSI metrics for a set of multiple corresponding operational modes of the network entity, where each CSI metric corresponds to an antenna group of a set of multiple antenna groups of the UE. In some examples, aspects of the operations of 905 may be performed by a CSI metric component 425.

At 910, the method may include selecting a first antenna group of the set of multiple antenna groups of the UE based on at least a first CSI metric of the set of multiple CSI metrics and an operational mode of the network entity. In some examples, aspects of the operations of 910 may be performed by an antenna selection component 430.

At 915, the method may include receiving an indication of the operational mode of the network entity and a time-period associated with a continuation of the operational mode, and where the first antenna group is selected based on the time-period associated with the operational mode. In some examples, aspects of the operations of 915 may be performed by a communications manager 435.

At 920, the method may include communicating with the network entity using the first antenna group in accordance with the first CSI metric of the set of multiple CSI metrics. In some examples, aspects of the operations of 920 may be performed by a communications manager 435.

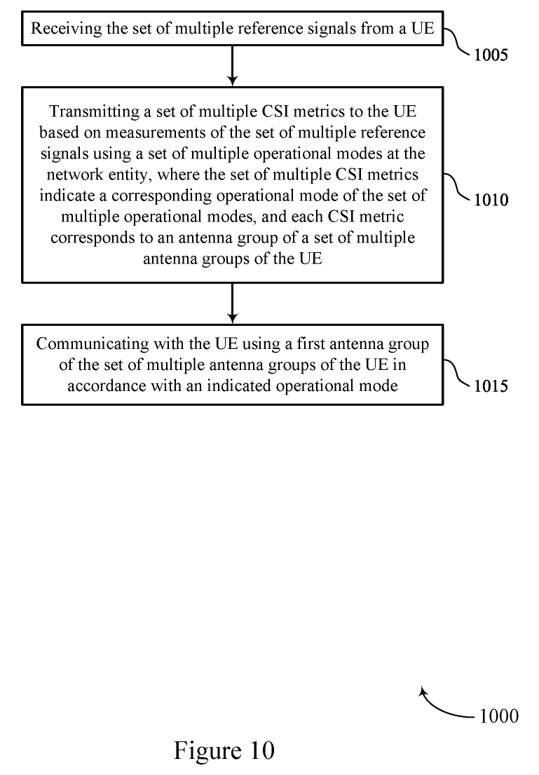

FIG. 10 shows an example of a method 1000 that supports techniques for UE antenna selection in wireless communications based on energy savings operational modes. Operations of the method 1000 may be performed by a network entity 105 or its components (such as using a processing system configured to cause the network entity to perform one or more operations) as described herein.

At 1005, the method may include receiving a set of multiple reference signals from a UE. In some examples, aspects of the operations of 1005 may be performed by a reference signal measurement component 625. In some aspects, the set of multiple reference signals may be received over a set of multiple reference signal transmission opportunities, where at least a first reference signal transmission uses a first antenna group and at least a second reference signal transmission uses a second antenna group of a set of multiple antenna groups at the UE.

At 1010, the method may include transmitting a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of the set of multiple antenna groups of the UE. In some examples, aspects of the operations of 1010 may be performed by a CSI metric component 630.

At 1015, the method may include communicating with the UE using a first antenna group of the set of multiple antenna groups of the UE in accordance with an indicated operational mode. In some examples, aspects of the operations of 1015 may be performed by a communications manager 635.

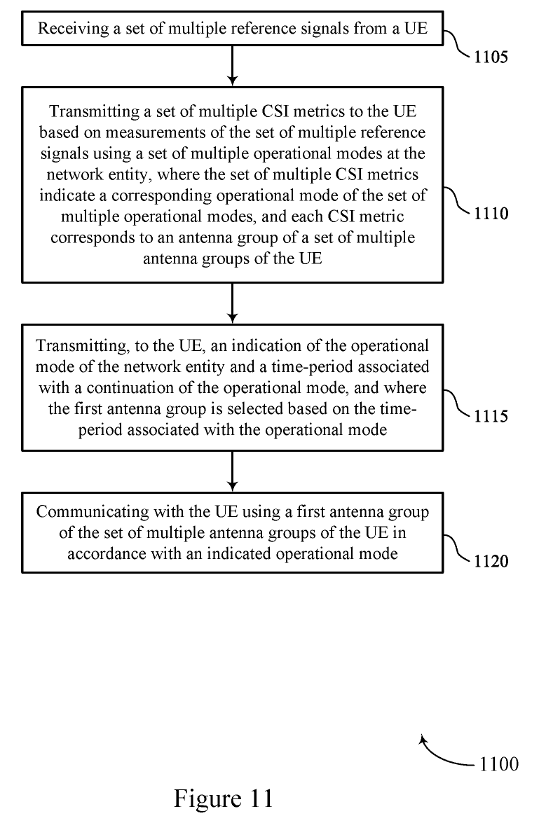

FIG. 11 shows an example of a method 1100 that supports techniques for UE antenna selection in wireless communications based on energy savings operational modes. Operations of the method 1100 may be performed by a network entity 105 or its components (such as using a processing system configured to cause the network entity to perform one or more operations) as described herein.

At 1105, the method may include receiving a set of multiple reference signals from a UE. In some examples, aspects of the operations of 1105 may be performed by a reference signal measurement component 625.

At 1110, the method may include transmitting a set of multiple CSI metrics to the UE based on measurements of the set of multiple reference signals using a set of multiple operational modes at the network entity, where the set of multiple CSI metrics indicate a corresponding operational mode of the set of multiple operational modes, and each CSI metric corresponds to an antenna group of a set of multiple antenna groups of the UE. In some examples, aspects of the operations of 1110 may be performed by a CSI metric component 630.

At 1115, the method may include transmitting, to the UE, an indication of the operational mode of the network entity and a time-period associated with a continuation of the operational mode, and where the first antenna group is selected based on the time-period associated with the operational mode. In some examples, aspects of the operations of 1115 may be performed by a communications manager 635.

At 1120, the method may include communicating with the UE using a first antenna group of the set of multiple antenna groups of the UE in accordance with an indicated operational mode. In some examples, aspects of the operations of 1120 may be performed by a communications manager 635.

Implementation examples are described in the following numbered clauses:

Aspect 1: A method for wireless communications at a UE, comprising: receiving, from a network entity, a plurality of CSI metrics for a plurality of corresponding operational modes of the network entity, wherein each CSI metric corresponds to an antenna group of a plurality of antenna groups of the UE; selecting a first antenna group of the plurality of antenna groups of the UE based at least in part on at least a first CSI metric of the plurality of CSI metrics and an operational mode of the network entity; and communicating with the network entity using the first antenna group in accordance with the first CSI metric of the plurality of CSI metrics.

Aspect 2: The method of aspect 1, further comprising: transmitting a plurality of reference signals to the network entity over a plurality of reference signal transmission opportunities, wherein at least a first reference signal transmission uses the first antenna group and at least a second reference signal transmission uses a second antenna group of the plurality of antenna groups.

Aspect 3: The method of any of aspects 1 through 2, wherein each CSI metric of the plurality of CSI metrics is associated with an operational mode of the plurality of operational modes of the network entity.

Aspect 4: The method of aspect 3, further comprising: receiving an indication of a mapping between each CSI metric and one of the plurality of operational modes of the network entity.

Aspect 5: The method of any of aspects 3 through 4, wherein one or more CSI metrics of a first operational mode are extrapolated from a CSI metric of a second operational mode of the network entity.

Aspect 6: The method of any of aspects 1 through 5, wherein the plurality of CSI metrics include one or more of an index value to a CQI or MCS table, an uplink SNR, an uplink signal strength metric, an uplink channel impulse response (CIR) vector estimate, or any combination thereof.

Aspect 7: The method of any of aspects 1 through 6, wherein the first antenna group is selected based at least in part on the plurality of CSI metrics and a network energy savings (NES) mode indicated by the network entity.

Aspect 8: The method of any of aspects 1 through 7, further comprising: transmitting an antenna group information message to the network entity that indicates the plurality of antenna groups of the UE and available combinations of the plurality of antenna groups.

Aspect 9: The method of any of aspects 1 through 8, further comprising: transmitting an indication of which antenna groups of the plurality of antenna groups of the UE are used for one or more uplink reference signal transmissions from the UE.

Aspect 10: The method of any of aspects 1 through 9, wherein the plurality of CSI metrics include CQI or MCS feedback for two or more antenna groups of the plurality of antenna groups of the UE, and the first antenna group includes one or more antennas of the UE that are included in one of the plurality of antenna groups.

Aspect 11: The method of aspect 10, wherein the plurality of CSI metrics further indicate one or more alternate antenna groups that are available for selection at the UE.

Aspect 12: The method of any of aspects 1 through 11, further comprising: receiving an indication of the operational mode of the network entity and a time-period associated with a continuation of the operational mode, and wherein the first antenna group is selected based at least in part on the time-period associated with the operational mode.

Aspect 13: A method for wireless communications at a network entity, comprising: receiving a plurality of reference signals from a UE; transmitting a plurality of CSI metrics to the UE based at least in part on measurements of the plurality of reference signals using a plurality of operational modes at the network entity, wherein the plurality of CSI metrics indicate a corresponding operational mode of the plurality of operational modes, and each CSI metric corresponds to an antenna group of a plurality of antenna groups of the UE; and communicating with the UE using a first antenna group of the plurality of antenna groups of the UE in accordance with an indicated operational mode.

Aspect 14: The method of aspect 13, further comprising: receiving, from the UE, a plurality of reference signals over a plurality of reference signal transmission opportunities, wherein at least a first reference signal transmission uses the first antenna group and at least a second reference signal transmission uses a second antenna group of the plurality of antenna groups at the UE.

Aspect 15: The method of any of aspects 13 through 14, wherein each CSI metric of the plurality of CSI metrics is associated with an operational mode of the plurality of operational modes of the network entity.

Aspect 16: The method of aspect 15, further comprising: transmitting an indication of a mapping between each CSI metric and one of the plurality of operational modes of the network entity.

Aspect 17: The method of any of aspects 15 through 16, wherein one or more CSI metrics of a first operational mode are extrapolated from a CSI metric of a second operational mode of the network entity.

Aspect 18: The method of any of aspects 13 through 17, wherein the plurality of CSI metrics include one or more of an index value to a CQI or MCS table, an uplink SNR, an uplink signal strength metric, an uplink channel impulse response (CIR) vector estimate, or any combination thereof.

Aspect 19: The method of any of aspects 13 through 18, further comprising: receiving an antenna group information message from the UE that indicates the plurality of antenna groups of the UE and available combinations of the plurality of antenna groups.

Aspect 20: The method of any of aspects 13 through 19, further comprising: receiving an indication of which antenna groups of the plurality of antenna groups of the UE are used for one or more uplink reference signal transmissions from the UE.

Aspect 21: The method of any of aspects 13 through 20, wherein the plurality of CSI metrics include CQI or MCS feedback for two or more antenna groups of the plurality of antenna groups of the UE, and the first antenna group includes one or more antennas of the UE that are included in one of the plurality of antenna groups.

Aspect 22: The method of aspect 21, wherein the plurality of CSI metrics further indicate one or more alternate antenna groups that are available for selection at the UE.

Aspect 23: The method of any of aspects 13 through 22, further comprising: transmitting, to the UE, an indication of the operational mode of the network entity and a time-period associated with a continuation of the operational mode, and wherein the first antenna group is selected based at least in part on the time-period associated with the operational mode.

Aspect 24: A UE for wireless communications, comprising a processing system that includes processor circuitry and memory circuitry that stores code, the processing system configured to cause the UE to perform a method of any of aspects 1 through 12.

Aspect 25: A UE for wireless communications, comprising at least one means for performing a method of any of aspects 1 through 12.

Aspect 26: A non-transitory computer-readable medium storing code for wireless communications, the code comprising instructions executable by one or more processors to perform a method of any of aspects 1 through 12.

Aspect 27: A network entity for wireless communications, comprising a processing system that includes processor circuitry and memory circuitry that stores code, the processing system configured to cause the network entity to perform a method of any of aspects 13 through 23.

Aspect 28: A network entity for wireless communications, comprising at least one means for performing a method of any of aspects 13 through 23.

Aspect 29: A non-transitory computer-readable medium storing code for wireless communications, the code comprising instructions executable by one or more processors to perform a method of any of aspects 13 through 23.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software components, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, from a network entity, a plurality of channel state information (CSI) metrics for a plurality of corresponding operational modes of the network entity, wherein each CSI metric corresponds to an antenna group of a plurality of antenna groups of the UE;
select a first antenna group of the plurality of antenna groups of the UE based at least in part on at least a first CSI metric of the plurality of CSI metrics and an operational mode of the network entity; and
communicate with the network entity using the first antenna group in accordance with the first CSI metric of the plurality of CSI metrics.

2. The UE of claim 1, wherein the processing system is further configured to cause the UE to:
transmit a plurality of reference signals to the network entity over a plurality of reference signal transmission opportunities, wherein at least a first reference signal transmission uses the first antenna group and at least a second reference signal transmission uses a second antenna group of the plurality of antenna groups.

3. The UE of claim 1, wherein each CSI metric of the plurality of CSI metrics is associated with an operational mode of the plurality of operational modes of the network entity.

4. The UE of claim 3, wherein the processing system is further configured to cause the UE to:
receive an indication of a mapping between each CSI metric and one of the plurality of operational modes of the network entity.

5. The UE of claim 3, wherein one or more CSI metrics of a first operational mode are extrapolated from a CSI metric of a second operational mode of the network entity.

6. The UE of claim 1, wherein the plurality of CSI metrics include one or more of an index value to a channel quality information (CQI) or modulation and coding scheme (MCS) table, an uplink signal-to-noise ratio (SNR), an uplink signal strength metric, an uplink channel impulse response (CIR) vector estimate, or any combination thereof.

7. The UE of claim 1, wherein the first antenna group is selected based at least in part on the plurality of CSI metrics and a network energy savings (NES) mode indicated by the network entity.

8. The UE of claim 1, wherein the processing system is further configured to cause the UE to:
transmit an antenna group information message to the network entity that indicates the plurality of antenna groups of the UE and available combinations of the plurality of antenna groups.

9. The UE of claim 1, wherein the processing system is further configured to cause the UE to:
transmit an indication of which antenna groups of the plurality of antenna groups of the UE are used for one or more uplink reference signal transmissions from the UE.

10. The UE of claim 1, wherein the plurality of CSI metrics include channel quality information (CQI) or modulation and coding scheme (MCS) feedback for two or more antenna groups of the plurality of antenna groups of the UE, and the first antenna group includes one or more antennas of the UE that are included in one of the plurality of antenna groups.

11. The UE of claim 10, wherein the plurality of CSI metrics further indicate one or more alternate antenna groups that are available for selection at the UE.

12. The UE of claim 1, wherein the processing system is further configured to cause the UE to:
receive an indication of the operational mode of the network entity and a time-period associated with a continuation of the operational mode, and wherein the first antenna group is selected based at least in part on the time-period associated with the operational mode.

13. A method for wireless communications at a user equipment (UE), comprising:
receiving, from a network entity, a plurality of channel state information (CSI) metrics for a plurality of corresponding operational modes of the network entity, wherein each CSI metric corresponds to an antenna group of a plurality of antenna groups of the UE;
selecting a first antenna group of the plurality of antenna groups of the UE based at least in part on at least a first CSI metric of the plurality of CSI metrics and an operational mode of the network entity; and
communicating with the network entity using the first antenna group in accordance with the first CSI metric of the plurality of CSI metrics.

14. The method of claim 13, further comprising:
transmitting a plurality of reference signals to the network entity over a plurality of reference signal transmission opportunities, wherein at least a first reference signal transmission uses the first antenna group and at least a second reference signal transmission uses a second antenna group of the plurality of antenna groups.

15. The method of claim 13, wherein each CSI metric of the plurality of CSI metrics is associated with an operational mode of the plurality of operational modes of the network entity.

16. The method of claim 15, further comprising:
receiving an indication of a mapping between each CSI metric and one of the plurality of operational modes of the network entity.

17. The method of claim 15, wherein one or more CSI metrics of a first operational mode are extrapolated from a CSI metric of a second operational mode of the network entity.

18. The method of claim 13, wherein the plurality of CSI metrics include one or more of an index value to a channel quality information (CQI) or modulation and coding scheme (MCS) table, an uplink signal-to-noise ratio (SNR), an uplink signal strength metric, an uplink channel impulse response (CIR) vector estimate, or any combination thereof.

19. The method of claim 13, wherein the first antenna group is selected based at least in part on the plurality of CSI metrics and a network energy savings (NES) mode indicated by the network entity.

20. A non-transitory computer-readable medium storing code for wireless communications, the code comprising instructions executable by one or more processors to:
receive, at a user equipment (UE) from a network entity, a plurality of channel state information (CSI) metrics for a plurality of corresponding operational modes of the network entity, wherein each CSI metric corresponds to an antenna group of a plurality of antenna groups of the UE;
select a first antenna group of the plurality of antenna groups of the UE based at least in part on at least a first CSI metric of the plurality of CSI metrics and an operational mode of the network entity; and
communicate with the network entity using the first antenna group in accordance with the first CSI metric of the plurality of CSI metrics.
